(19) United States
(12) Patent Application Publication
(10) Pub. No.: US 2017/0259883 A1
(43) Pub. Date: Sep. 14, 2017

(54) DRIVE UNIT FOR BICYCLE

(71) Applicant: Shimano Inc., Sakai, Osaka (JP)

(72) Inventor: Takashi YAMAMOTO, Sakai, Osaka (JP)

(21) Appl. No.: 15/528,722

(22) PCT Filed: Dec. 17, 2015
(86) PCT No.: PCT/JP2015/085314

§ 371 Date: May 22, 2017

(30) Foreign Application Priority Data
Dec. 17, 2014 (JP) 2014-255522

(51) Int. Cl. B62M 11/14; F16H 3/72; F16D 41/24; B62M 6/45; B62M 6/55; B62M 6/70

(52) U.S. Cl. CPC B62M 11/145; B62M 6/55; B62M 6/70; F16D 41/24; B62M 6/45; F16H 3/725; B62M 9/06

(57) ABSTRACT

A bicycle drive unit includes a planetary gear mechanism, a first motor and a second motor. The planetary gear mechanism includes a sun gear, a ring gear, a plurality of planetary gears and a carrier. The ring gear is disposed around the sun gear on the same axis as the sun gear. The planetary gears are disposed between the sun gear and the ring gear. The carrier rotatably holds the planetary gears and receives an input rotation of a crankshaft. The first motor is configured to transmit torque to the carrier. The second motor is configured to transmit torque to the sun gear and control the rotation of the sun gear.

### CROSS-REFERENCE TO RELATED APPLICATIONS

This application is a U.S. National stage application of International Application No. PCT/JP2015/085314, filed on Dec. 17, 2015, which claims priority to Japanese Patent Application No. 2014-255522 filed on Dec. 17, 2014

### BACKGROUND

Field of the Invention

The present invention relates to a bicycle drive unit.

Background Information

Japanese Laid-Open Patent Publication No. 10-203466 (Patent document 1) describes a bicycle including a continuously variable transmission device of the prior art. The continuously variable transmission device includes a planetary gear mechanism that is coupled to a crankshaft and a motor that controls the rotation of the elements configuring the planetary gear mechanism.

### SUMMARY

The continuously variable transmission device of patent document 1 is configured to change the transmission ratio in a stepless manner. However, the same motor is used to change the transmission ratio of the planetary gear mechanism and transmit torque to the planetary gear mechanism. Thus, the transmission ratio and the torque cannot be separately changed.

The inventor of the present invention has developed a bicycle drive unit that allows for the execution of control in accordance with the riding conditions. It is an object of the present invention to provide a bicycle chive unit that executes control in accordance with the riding conditions.

In a first aspect of the invention, a bicycle drive unit includes a planetary gear mechanism, a first motor, and a second motor. The planetary gear mechanism includes a sun gear, a ring gear arranged around the sun gear coaxially with the sun gear, planetary gears located between the sun gear and the ring gear, and a carrier that rotatably holds the planetary gears and receives rotation of a crankshaft. The first motor is configured to transmit torque to the carrier. The second motor is configured to transmit torque to the sun gear and control rotation of the sun gear.

In several examples, the bicycle drive unit further includes an output portion that can be coupled to a front sprocket. The ring gear is connected to the output portion. One embodiment of the bicycle drive unit further includes the crankshaft. The crankshaft and the carrier are connected.

In several examples, the carrier is arranged around the crankshaft to be coaxially with the crankshaft. In several examples, the sun gear is arranged around the crankshaft to be coaxially with the crankshaft.

In several examples, the second motor is arranged around the crankshaft to be coaxially with the crankshaft. In several examples, the sun gear is formed integrally with an output shaft of the second motor.

in several examples, a rotation shaft of the first motor is separated from the crankshaft in a radial direction of the crankshaft. Several examples further include a housing that accommodates at least the planetary gear mechanism. A one-way clutch is located between the sun gear and the housing. The one-way clutch allows the sun gear to rotate relative to the housing in only a single direction.

In several examples, the bicycle drive unit further includes a housing that accommodates at least the planetary gear mechanism and a one-way clutch located between an output shaft or rotor of the second motor and the housing. The one-way clutch allows the output shaft or rotor of the second motor to rotate relative to the housing in only a single direction.

In several examples, the housing includes a support located in a space extending between an inner circumference of the sun gear and the crankshaft. The one-way clutch is located between the sun gear and the support.

In several examples, the bicycle drive unit further includes a one-way clutch located between the crankshaft or the carrier and the ring gear or the output portion. The one-way clutch allows the output portion to rotate relative to the crankshaft in only a single direction.

In several examples, at least one of the first motor and the second motor is accommodated in the housing. In several examples, the second motor changes a transmission ratio of the planetary gear mechanism including at least a range from 1.2 to 1.5.

In several examples, the second motor changes a transmission ratio of the planetary gear mechanism in a range from 0.2 to 3.0. In several examples, the bicycle drive unit further includes a controller that controls the first motor and the second motor.

The present invention provides a bicycle drive unit that allows for the execution of control in accordance with the riding conditions. Other aspects and advantages of the present invention will become apparent from the following description, taken in conjunction with the accompanying drawings.

### BRIEF DESCRIPTION OF THE DRAWINGS

FIG. 1 is a side view of a bicycle including one embodiment of a bicycle drive unit.

FIG. 2 is a cross-sectional view of the bicycle drive unit shown in FIG. 1.

FIG. 3 is a schematic diagram showing the rotation direction of each element in a planetary gear mechanism shown in FIG. 2.

FIG. 4 is a schematic diagram of the bicycle drive unit shown in FIG. 2.

FIG. 5 is a schematic diagram showing a comparative example of a bicycle drive unit.

FIG. 6 is a schematic diagram showing a first modified example of a bicycle drive unit.

FIG. 7 is a schematic diagram showing a second modified example of a bicycle drive unit.

FIG. 8 is a schematic diagram showing a third modified example of a bicycle drive unit.

FIG. 9 is a schematic diagram showing a fourth modified example of a bicycle drive unit.

FIG. 10 is a schematic diagram showing a fifth modified example of a bicycle drive unit.

FIG. 11 is a schematic diagram showing a sixth modified example of a bicycle drive unit.

FIG. 12 is a schematic diagram showing a seventh modified example of a bicycle drive unit.

FIG. 13 is a schematic diagram showing an eighth modified example of a bicycle drive unit.

FIG. 14 is a schematic diagram showing a ninth modified example of a bicycle drive unit.

FIG. 15 is a schematic diagram showing a tenth modified example of a bicycle drive unit.

FIG. 16 is a schematic diagram showing an eleventh modified example of a bicycle drive unit.

### DETAILED DESCRIPTION OF THE EMBODIMENTS

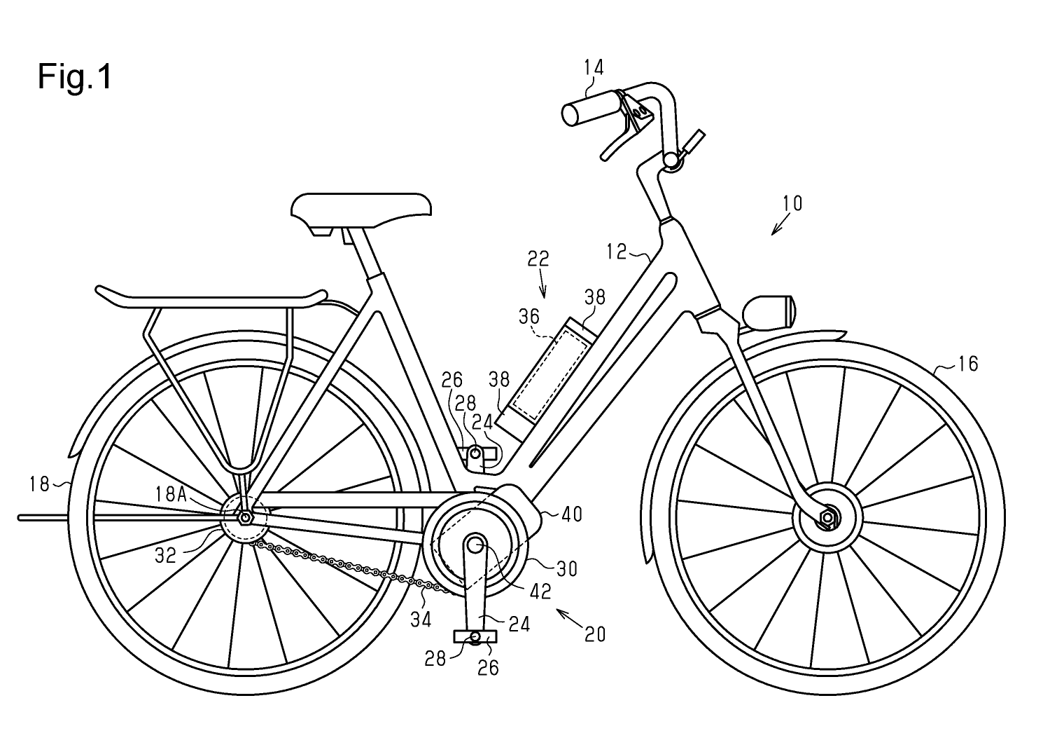

The structure of a bicycle including a bicycle drive unit will now be described with reference to FIG. 1. A bicycle 10 includes a frame 12, a handlebar 14, a front wheel 16, a rear wheel 18, a drive mechanism 20, a battery unit 22, and a drive unit 40.

The drive mechanism 20 includes left and right crank arms 24, left and right pedals 26, a front sprocket 30, a rear sprocket 32, and a chain 34. The left and right crank arms 24 are rotatably coupled to the frame 12 by a crankshaft 42 of the drive unit 40. The pedals 26 are coupled to the crank arms 24 and are rotatable about pedal shafts 28.

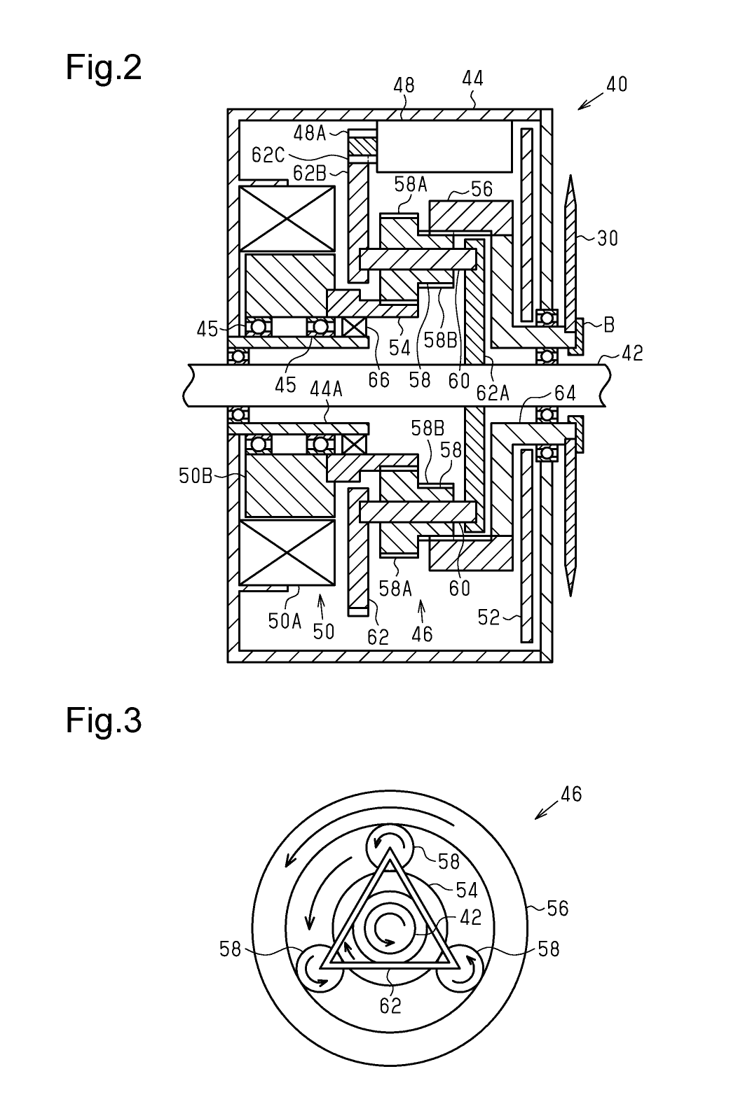

The front sprocket 30 is coupled to an output portion 64 (refer to FIG. 2) of the drive unit 40. The front sprocket 30 is coaxial with the crankshaft 42. The rear sprocket 32 is coupled in a manner rotatable about an axle 18A of the rear wheel 18. The rear sprocket 32 is coupled to the rear wheel 18 by a one-way clutch, The chain 34 is wound around the front sprocket 30 and the rear sprocket 32. The application of human power to the pedals 26 rotates the crank arms 24. As a result, the front sprocket 30, the chain 34, and the rear sprocket 32 rotate the rear wheel 18.

The battery unit 22 includes a battery 36 and a battery holder 38, which allows the battery 36 to be attached to the frame 12 in a removable manner. The battery 36 includes one or more battery cells. The battery 36 is configured by a rechargeable battery. The battery 36 is electrically connected to the drive unit 40 to supply the drive unit 40 with power.

As shown in FIG. 2, the drive unit 40 includes a planetary gear mechanism 46, a first motor 48, and a second motor 50. The drive unit 40 may also include the crankshaft 42, a housing 44, and a controller 52.

The housing 44 accommodates the planetary gear mechanism 46, the first motor 48, the second motor 50, and the controller 52. The housing 44 rotatably supports the crankshaft 42. The crankshaft 42 extends through the housing 44.

The planetary gear mechanism 46 includes a sun gear 54, a ring gear 56, planetary gears 58, planetary pins 60, and a carrier 62. The sun gear 54 is arranged around the crankshaft 42 to be coaxially with the crankshaft 42.

The ring gear 56 is located outward from the sun gear 54 in the radial direction of the crankshaft 42. The ring gear 56 is arranged around the crankshaft 42 to be coaxially with the crankshaft 42. Thus, the ring gear 56 is arranged around the sun gear 54 coaxially with the sun gear 54. The output portion 64 is connected to the ring gear 56. The output portion 64 includes one end accommodated in the housing 44 and another end located outside the housing 44. A bolt B is fastened to the inner circumference of the output portion 64 at the part located outside the housing 44. The front sprocket 30 is supported by a spline so that the front sprocket 30 is non-rotatable in the circumferential direction relative to the output portion 64. The bolt B couples the front sprocket 30 to the output portion 64 so that the front sprocket 30 is not movable in the axial direction.

The planetary gears 58 are located between the sun gear 54 and the ring gear 56. The planetary gears 58 each include a large diameter portion 58A and a small diameter portion 58B. A gear on the outer circumference of the large diameter portion 58A is arranged opposing the outer circumference of the sun gear 54 and engaged with the sun gear 54. A gear on the outer circumference of the small diameter portion 58B is arranged opposing the inner circumference of the ring gear 56 and engaged with the ring gear 56. Instead of the planetary gear 58 that includes the large diameter portion 58A and the small diameter portion 58B, a normal planetary gear including a single gear may be used.

The planetary pins 60 extend through the corresponding planetary gears 58 in the axial direction. Each planetary pin 60 rotatably supports the corresponding planetary gear 58. The two ends of each planetary pin 60 are rotatably supported by the carrier 62 As long as the two ends of each planetary pin 60 are rotatably supported by the carrier 62, the planetary pin 60 may be supported by the corresponding planetary gear 58 in a non-rotatable manner, In case each planetary pin 60 is rotatably supported by the corresponding planetary gear 58, the two ends of the planetary pin 60 may be supported by the carrier 62 in a non-rotatable manner.

The carrier 62 is arranged around the crankshaft 42 to be coaxially with the crankshaft 42. The carrier 62 rotatably holds the planetary gears 58 with the planetary pins 60. Thus, the planetary gears 58 orbit the sun gear 54 between the sun gear 54 and the ring gear 56.

The carrier 62 includes a first carrier 62A, which supports one end of each planetary pin 60, and a second carrier 62B, which supports the other end of each planetary pin 60. The first carrier 62A is opposed to the end of each planetary gear 58 located at the side of the small diameter portion 58B. The second carrier 62B is opposed to the end of each planetary gear 58 located at the side of the large diameter portion 58A. The first carrier 62A and the second carrier 62B are coupled together and integrally rotated, The first carrier 62A can be integrally formed with the second carrier 62B.

The crankshaft 42 may be connected to the inner circumference of the first carrier 62A through, for example, spline-fitting or press-fitting. The carrier 62 rotates integrally with the crankshaft 42. The rotation of the crankshaft 42 is input to the carrier 62.

The first motor 48 includes a rotation shaft that is separated from the crankshaft 42 in the radial direction of the crankshaft 42. The first motor 48 includes an output gear 48A that is engaged with a gear 62C formed by the outer circumference of the second carrier 62B. The first motor 48 transmits torque to the carrier 62 through the gear 62C. A one-way clutch may be located between the rotation shaft of the first motor 48 and the carrier 62. The one-way clutch may be configured to transmit the rotation produced by the first motor 48 to the carrier 62 but not transmit the rotation of the carrier 62 to the first motor 48 if the crankshaft 42 rotates in a certain rotation direction.

The second motor 50 is arranged around the crankshaft 42 to be coaxially with the crankshaft 42. The second motor 50 is arranged next to the planetary gear mechanism 46 in the axial direction of the crankshaft 42. The second motor 50 is located farther from the front sprocket 30 than the planetary gear mechanism 46 in the axial direction of the crankshaft 42.

The second motor 50 is an inner rotor type motor and includes a stator 50A, which is supported by the housing 44, and a rotor 50B, which is arranged in the stator 50A. The housing 44 includes a support 44A located between the inner circumference of the rotor 50B and the crankshaft 42. The support 44A is tubular and coaxial with the crankshaft 42. The rotor 50B is rotatably supported by the support 44A. The rotor 5013 is supported by two bearings 45 on the support 44A. The rotor 50B includes an axial end coupled to one end of the sun gear 54. That is, the sun gear 54 is formed integrally with the output shaft of the second motor 50. The rotor 50B and the sun gear 54 are rotatable relative to the crankshaft 42. The second motor 50 transmits torque to the sun gear 54 and controls the rotation of the sun gear 54. The stator 50A is fixed to the housing 44.

The support 44A includes a portion extending in a space between the inner circumference of the sun gear 54 and the crankshaft 42. A one-way clutch 66 is located between the inner circumference of the sun gear 54 and the outer circumference of the support 44A. The one-way clutch 66 allows the sun gear 54 to rotate only in a single direction with respect to the support 44A, More specifically, the one-way clutch 66 allows rotation of the sun gear 54 relative to the support 44A in a direction reverse to the direction in which the crankshaft 42 rotates as the bicycle 10 travels forward (hereinafter referred to as “the reverse rotation direction”). Further, the one-way clutch 66 restricts rotation of the sun gear 54 relative to the support 44A in the direction in which the crankshaft 42 rotates as the bicycle 10 travels forward(hereinafter referred to as “the forward rotation direction”). In other words, the sun gear 54 cannot be rotated relative to the support 44A in the forward rotation direction. In a case in which the second motor 50 is not supplied with power and rotation in the forward rotation direction is input to the crankshaft 42, the one-way clutch 66 restricts rotation of the sun gear 54. Thus, the planetary gear mechanism 46 increases the speed of the forward rotation direction rotation produced by the crankshaft 42 and transmits the rotation to the output portion 64. The one-way clutch 66 may be formed by a roller clutch or a pawl-type clutch.

The controller 52 includes a drive circuit that drives the first motor 48 and a drive circuit that drives the second motor 50. The controller 52 uses power that is supplied from the battery 36 (refer to FIG. 1) to drive the first motor 48 and the second motor 50. The controller 52 can be connected to the first motor 48 and the second motor 50 by, for example, conductors.

The controller 52 controls the first motor 48 and the second motor 50 based on signals from, for example, a torque sensor and a bicycle speed sensor (neither shown). The torque sensor detects human drive power. The torque sensor is realized by, for example, a strain sensor arranged on the first carrier 62A. In this case, the output from the strain gauge is sent to the controller 52 by a wireless communication device or a slip ring. The strain sensor is, for example, a strain gauge. Instead of the torque sensor, the controller 52 may calculate torque from the current applied to at least one of the first motor 48 and the second motor 50. In a case in which the controller 52 receives an operation signal for changing the assist force from an operation unit (not shown), the controller 52 controls the first motor 48 to increase the output of the first motor 48 with respect to the human drive power. Further, in a case in which the controller 52 receives an operation signal for changing a transmission ratio GR of the planetary gear mechanism 46, which is the ratio of the rotation speed output from the planetary gear mechanism 46 to the rotation speed input to the planetary gear mechanism 46, the controller 52 controls the second motor 50 so that the ratio of the rotation speed (or rotation angle) of the output portion 64 to the rotation speed (or rotation angle) of the crankshaft 42 is a predetermined transmission ratio.

The controller 52 drives the first motor 48 to transmit forward rotation direction torque to the carrier 62. This adds assist force to the torque received from the crankshaft 42 and output from the planetary gear mechanism 46.

The controller 52 drives the second motor 50 to transmit torque in the reverse rotation direction to the sun gear 54. Referring to FIG. 3, the rotation of the sun gear 54 accelerates the revolving speed of the planetary gears 58 around the sun gear 54. This increases the rotation speed of the ring gear 56 and increases the transmission ratio GR. The transmission ratio GR is continuously changed in accordance with the rotation speed of the sun gear 54. Alternatively, the controller 52 may execute control that changes the transmission ratio GR, that is, the rotation speed of the sun gear 54, in a stepped manner. The controller 52 is connected to an external device in a manner enabling wired communication or wireless communication. Further, the controller 52 may be configured to change the number of steps or the degree of the transmission ratio GR in accordance with instructions from the external device. The external device may be, for example, a cycle computer or a personal computer.

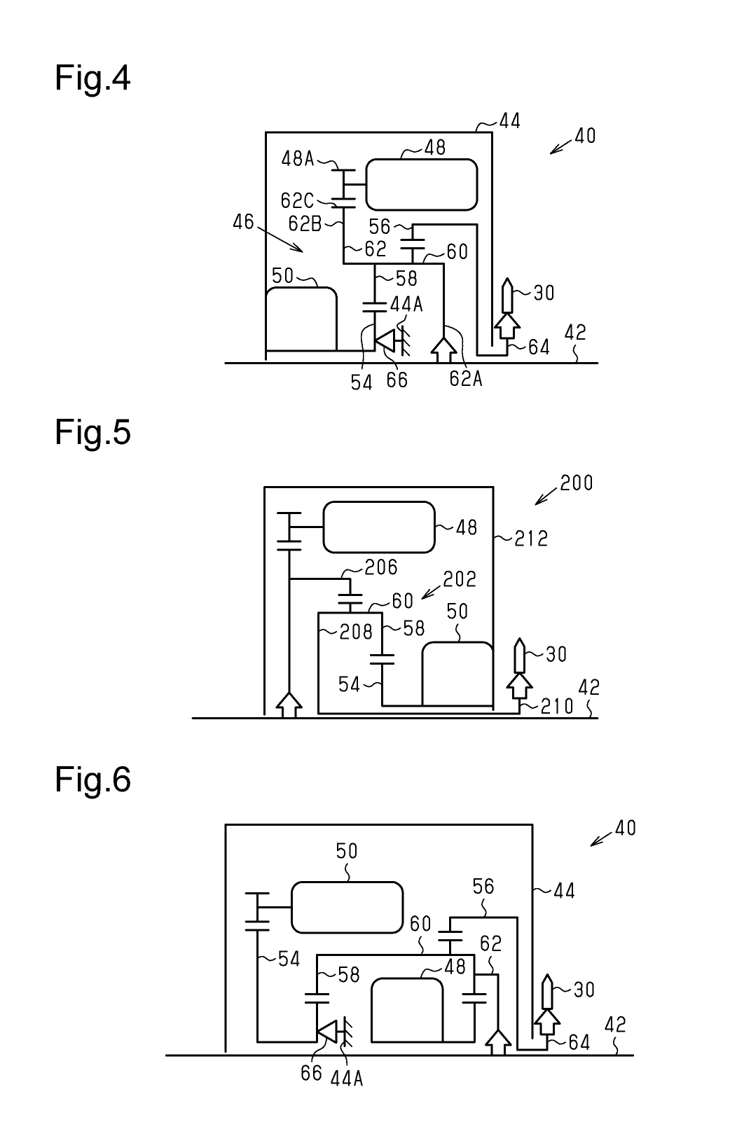

In a case in which the controller 52 shown in FIG. 2 stops supplying the second motor 50 with power, the second motor 50 is deactivated. As shown in FIG. 4, the one-way clutch 66 is located between the sun gear 54 and the support 44A. This restricts rotation of the sun gear 54 relative to the support 44A. Thus, in a case in which the controller 52 stops supplying the second motor 50 with power, the transmission ratio GR is maintained in accordance with the number of gears of the elements of the planetary gear mechanism 46. In the planetary gear mechanism 46, the carrier 62 functions as an input portion, and the ring gear 56 is connected to the output portion 64. Thus, in a case in which the sun gear 54 does not rotate relative to the support 44A, the rotation input to the planetary gear mechanism 46 is increased in speed and then output. Thus, in a case in which the controller 52 stops supplying the second motor 50 with power, the transmission ratio GR is 1 or greater, for example, 1.2 or greater.

Preferably, the second motor 50 changes the transmission ratio GR in at least the range of 1.2 to 1.5. The maximum value of the transmission ratio GR changed by the second motor 50 is, for example, 3.0 or less. In other words, the second motor 50 changes the transmission ratio GR in the range of 1 to 3.0.

The operation and advantages of the bicycle drive unit will now be described.

(1) The drive unit 40 includes the first motor 48 that transmits torque to the carrier 62 and the second motor 50 that controls rotation of the sun gear 54. Thus, the changing of the transmission ratio GR with the second motor 50 and the changing of the assist force with the first motor 48 are separately performed. This allows for the execution of control in accordance with the riding conditions. For example, the bicycle drive unit can be configured to accurately change the transmission ratio and the assist force in accordance with the riding conditions or the like.

(2) The transmission ratio GR of the planetary gear mechanism 46 is 1 or greater in a case in which rotation of the second motor 50 is stopped. Thus, in contrast with a planetary gear mechanism in which the transmission ratio GR is less than 1 in a case in which a second motor is stopped, the range of the transmission ratio GR at 1 or greater may be expanded without enlarging the second motor 50.

(3) The transmission ratio GR of the planetary gear mechanism 46 is 1 or greater. Thus, in a case in which the sun gear 54 is not rotating, the rotation speed of the ring gear 56 is greater than or equal to the rotation speed of the carrier 62. The first motor 48 is connected to the carrier 62. Thus, in contrast with a structure that connects a first motor to a ring gear in order to transmit torque, an increase in the rotation speed of the first motor 48 is limited in a case in which assist force is applied. This decreases the power consumption of the first motor 48.

(4) The second motor 50 is arranged around the crankshaft 42 to be coaxially with the crankshaft 42 Thus, in contrast with a structure that arranges the second motor 50 outward in the radial direction from the crankshaft 42, enlargement of the drive unit 40 is limited in the radial direction of the crankshaft 42.

(5) The sun gear 54 is formed integrally with the output shaft of the second motor 50. This reduces the number of components in the drive unit 40.

(6) The rotation shaft of the first motor 48 is separated from the crankshaft 42 in the radial direction of the crankshaft 42. Thus, in contrast with a case in which the rotation shaft of the first motor 48 is arranged to be coaxially with the crankshaft 42 of the drive unit 40, enlargement is limited in the axial direction of the crankshaft 42.

(7) In a case in which the one-way clutch 66 is not located between the sun gear 54 and the support 44A and the supply of power to the second motor 50 is stopped, rotation of the sun gear 54 around the support 44A is not restricted. Thus, revolving force in the reverse rotation direction is applied to the planetary gears 58, and the sun gear 54 is rotated in the forward rotation direction. As a result, the carrier 62 and the ring gear 56 will stop rotating relative to the housing 44, and the planetary gear mechanism 46 will not output rotation.

The drive unit 40 includes the one-way clutch 66 that is located between the sun gear 54 and the housing 44. This allows the planetary gear mechanism 46 to output rotation even in a case in which the supply of power to the second motor 50 is stopped. Further, to minimize the transmission ratio OR, the supply of power to the second motor 50 can be stopped. This allows power consumption to be decreased as compared with a structure that supplies the second motor 50 with power to maintain the phase of the sun gear 54 relative to the support 44A.

(8) The output portion 64 is located outward from the planetary gear mechanism 46 in the axial direction of the crankshaft 42. Thus, in contrast with a structure in which the portion to which the front sprocket 30 is coupled is located inside the planetary gear mechanism 46 in the axial direction of the crankshaft 42, the coupling and removal of the front sprocket 30 are facilitated.

(9) FIG. 5 shows a comparative example of a drive unit 200 that inputs the rotation of the crankshaft 42 to a ring gear 206 and outputs the rotation of a carrier 208. In the comparative example of the drive unit 200, the second motor 50 is supported by a. housing 212. Thus, in a case in which an output portion 210 is located at the outer side in the axial direction of the planetary gear mechanism 202 and the carrier 208 is located between the ring gear 206 and the second motor 50 in the axial direction of the planetary gear mechanism 202, the carrier 208 extends between the second motor 50 and the crankshaft 42. Thus, the carrier 208 and the planetary gear mechanism 202 have complicated structures.

In the drive unit 40, the output portion 64 is coupled to the ring gear 56. Thus, the carrier 62 has a simple structure. This simplifies the structure of the planetary gear mechanism 72 and limits enlargement of the drive unit 40.

The present invention is not limited to the above embodiment. For example, the present invention may be modified as described below. As shown in FIG. 6, the second motor 50 may be arranged at the radially outer side of the crankshaft 42. In this case, a stepped gear that is arranged to be coaxially with the crankshaft 42 may be used as the sun gear 54. The one-way clutch 66 may be located between the sun gear 54 and the housing 44.

As shown in FIG. 6, the first motor 48 may be arranged around the crankshaft 42 to be coaxially with the crankshaft 42. In this case, the carrier 62 may include an internal gear that is engaged with an output gear of the first motor 48.

The controller 52 can drive the second motor 50 in the forward rotation direction. In this case, the one-way clutch 66 is omitted. In a case in which the second. motor 50 rotates the sun gear 54 in the forward rotation direction, the transmission ratio GR is decreased. In a case in which the rotation speed of the second motor 50 is increased, the transmission ratio GR may be decreased to 1 or less. In this case, it is preferred that the second motor 50 change the transmission ratio GR in the range of 0.2 to 3.0.

A speed reduction mechanism may he located between the crankshaft 42 and the carrier 62 or between the ring gear 56 and the front sprocket 30. In this case, the speed reduction mechanism may decrease the transmission ratio GR to less than 1. The speed reduction gear may be realized by at least two or more gears or by a planetary gear mechanism.

The one-way clutch 66 may be located between the rotor 50B and the support 44A. Alternatively, the one-way clutch 66 may be located between the rotor 50B and a portion other than the support 44A of the housing 44.

The second motor 50 may be an outer rotor type motor in which the rotor 50B is arranged around the stator 50A. The sun gear 54 may be separate from the output shaft of the second motor 50, and the sun gear 54 may be connected through spline-fitting to the output shaft of the second motor 50. In this case, the one-way clutch 66 may be located between the output shaft of the second motor 50 and the support 44A.

The one-way clutch 66 may be omitted. In this case, to restrict rotation of the sun gear 54 relative to the housing 44, the second motor 50 is controlled so as not to produce rotation and thereby maintain the rotation phase of the sun gear 54 relative to the housing 44.

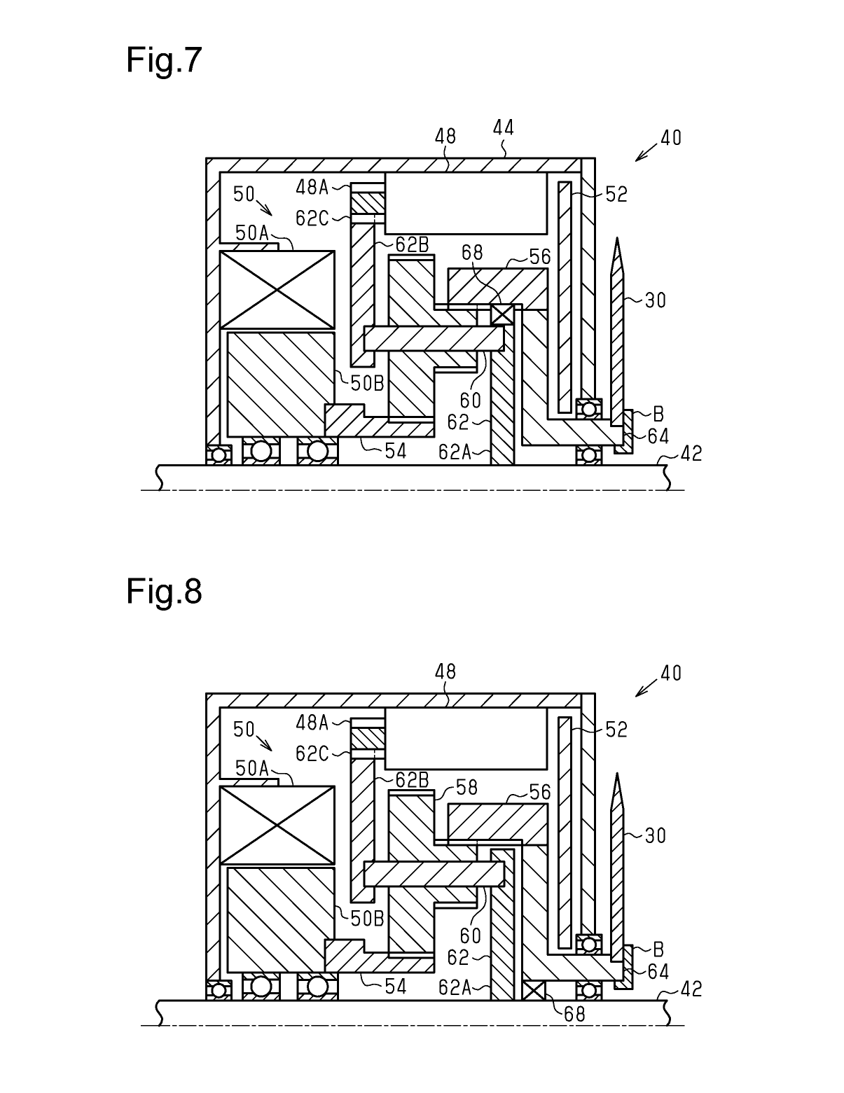

As shown in FIG. 7, instead of the one-way clutch 66, a one-way clutch 68 may be located between the carrier 62 and the ring gear 56. The one-way clutch 68 allows the output portion 64 and the ring gear 56 to rotate in the forward rotation direction relative to the crankshaft 42 and the carrier 62. More specifically, in a case in which the output portion 64 and the ring gear 56 rotate faster than the crankshaft 42 and the carrier 62, rotation of the output portion 64 and the ring gear 56 is allowed relative to the crankshaft 42 and the carrier 62. The one-way clutch 68 restricts rotation of the output portion 64 and the ring gear 56 in the reverse rotation direction relative to the crankshaft 42 and the carrier 62. More specifically, in a case in which the rotation speed of the output portion 64 and the ring gear 56 in the forward rotation direction becomes equal to the rotation speed of the crankshaft 42 and the carrier 62, the output portion 64 and the ring gear 56 are coupled to the crankshaft 42 and the carrier 62 and rotated integrally. Thus, for example, in a case in which the supply of power to the second motor 50 is stopped and the transmission ratio GR becomes 1, the one-way clutch 68 functions to rotate the carrier 62 and the ring gear 56 integrally in the forward rotation direction. Thus, even in a case in which the supply of power to the second motor 50 is stopped, the rotation of the crankshaft 42 can be transmitted to the front sprocket 30. The one-way clutch 68 may be formed by a roller clutch or a pawl-type clutch.

As shown in FIG. 8, in the modified example of FIG. 7, the one-way clutch 68 may be located between the crankshaft 42 and the output portion 64. This also obtains the advantages of the modified example shown in FIG. 7.

The crankshaft 42 may be omitted from the drive unit 40, and a crankshaft separate from the drive unit 40 may be coupled to the drive unit 40. At least one of the first motor 48 and the second motor 50 may be arranged outside the housing 44.

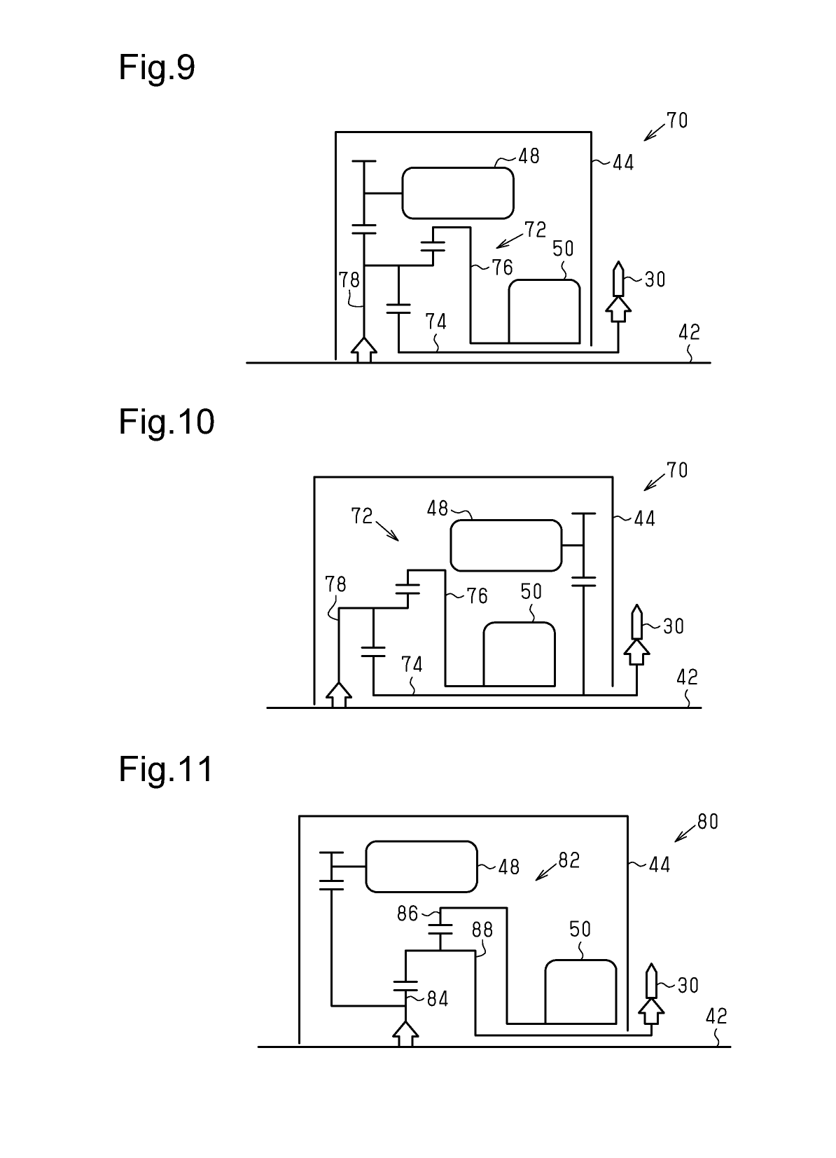

In a planetary gear mechanism 72 of a drive unit 70 shown in FIG. 9, the rotation of the crankshaft 42 is input to a carrier 78, and the rotation of a sun gear 74 is output to the front sprocket 30. A ring gear 76 is rotatable relative to the housing 44. The first motor 48 is connected to the carrier 78, and the torque of the first motor 48 is transmitted to the carrier 78. The second motor 50 is connected to the ring gear 76 to transmit torque to the ring gear 76 and control the rotation of the ring gear 76. In a case in which the rotation of the ring gear 76 relative to the housing 44 is restricted, the transmission ratio GR of the planetary gear mechanism 72 is less than 1. Thus, the transmission ratio GR may be changed in a stepless manner in a range of less than 1 and a range of 1 or greater by driving the second motor 50 in the reverse rotation direction. The transmission ratio GR may be further decreased by driving the second motor 50 in the forward rotation direction.

As shown in FIG. 10, in the drive unit 70 shown in FIG. 9, the first motor 48 may be connected to the sun gear 74. In this case, the torque of the first motor 48 is transmitted to the sun gear 74.

In a planetary gear mechanism 82 of a drive unit 80 shown in FIG. 11, the rotation of the crankshaft 42 is input to a sun gear 84, and the rotation of the carrier 88 is output to the front sprocket 30. The ring gear 86 is rotatable relative to the housing 44. The first motor 48 is connected to the sun gear 84, and the torque of the first motor 48 is transmitted to the sun gear 84. The second motor 50 is connected to the ring gear 86 to transmit torque to the ring gear 86 and control the rotation of the ring gear 86. In a case in which the rotation of the ring gear 86 relative to the housing 44 is restricted, the transmission ratio GR of the planetary gear mechanism 82 is less than 1. Thus, the transmission ratio GR may be changed in a stepless manner in a range of less than 1 and a range of 1 or greater by driving the second motor 50 in the forward rotation direction. The transmission ratio GR may be further decreased by driving the second motor 50 in the reverse rotation direction.

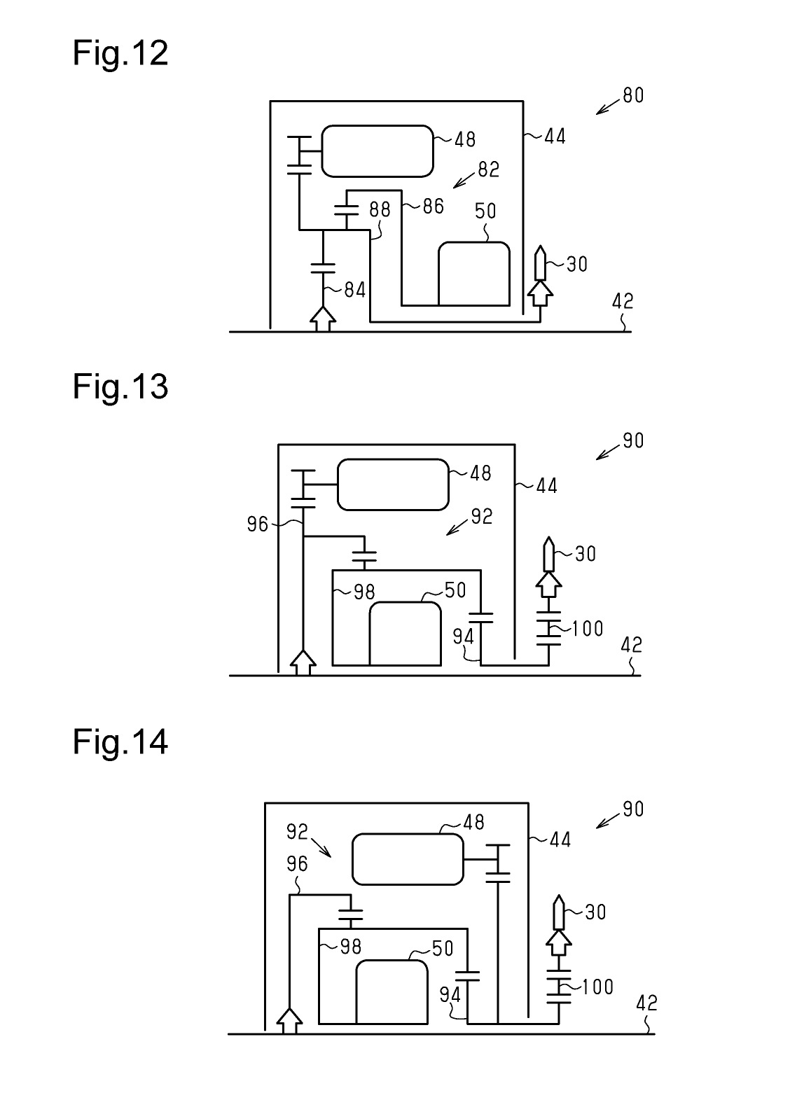

As shown in FIG. 12, in the drive unit 80 shown in FIG. 11, the first motor 48 can be connected to the carrier 88. In this case, the torque of the first motor 48 is transmitted to the carrier 88.

In a planetary gear mechanism 92 of a drive unit 90 shown in FIG. 13, the rotation of the crankshaft 42 is input to a ring gear 96, and the rotation of a sun gear 94 is output to the front sprocket 30. A carrier 98 is rotatable relative to the housing 44. The first motor 48 is connected to the ring gear 96, and the torque of the first motor 48 is transmitted to the ring gear 96. The second motor 50 is connected to the carrier 98 to transmit torque to the carrier 98 and control rotation of the carrier 98. In the planetary gear mechanism 92, in a case in which the rotation of the carrier 98 relative to the housing 44 is restricted, the rotation direction of the ring gear 96 differs from the rotation direction of the sun gear 94. Thus, a transmission gear 100 is located between the sun gear 94 and the front sprocket 30 to change the rotation direction. The transmission gear 100, the sun gear 94, and the front sprocket 30 form a planetary gear mechanism. In this case, the transmission gear 100 functions as a planetary gear, the sun gear 94 functions as a sun gear, and the front sprocket 30 functions as a ring gear. A carrier that supports the transmission gear 100 may be fixed to a housing to reverse the rotation direction of the sun gear 94 and the rotation direction of the front sprocket 30. The transmission gear 100 may be located between the crankshaft 42 and the ring gear 96.

As shown in FIG. 14, in the drive unit 90 shown in FIG. 13, the first motor 48 may be connected to the sun gear 94 In this case, the torque of the first motor 48 is transmitted to the sun gear 94.

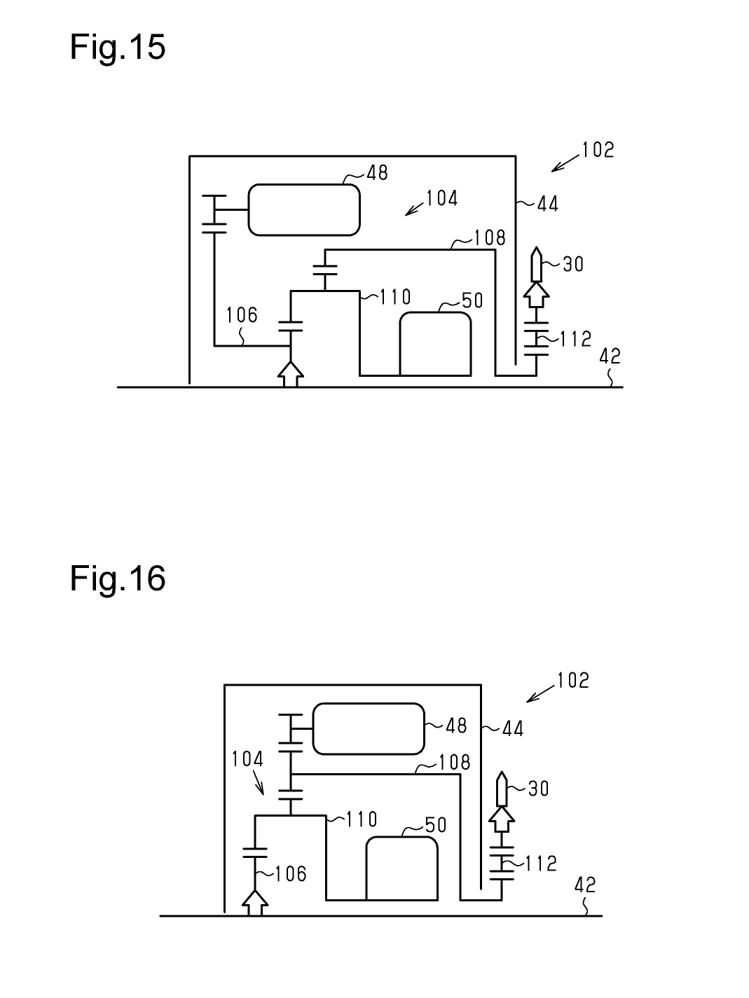

In a planetary gear mechanism 104 of a drive unit 102 shown in FIG. 15, the rotation of the crankshaft 42 is input to a sun gear 106, and the rotation of a ring gear 108 is output to the front sprocket 30. A carrier 110 is rotatable relative to the housing 44. The first motor 48 is connected to the sun gear 106, and the torque of the first motor 48 is transmitted to the sun gear 106. The second motor 50 is connected to the carrier 110 to transmit torque to the carrier 110 and control rotation of the carrier 110. In the planetary. gear mechanism 104, in a case in which the rotation of the carrier 110 relative to the housing 44 is restricted, the rotation direction of the sun gear 106 differs from the rotation direction of the ring gear 108. Thus, a transmission gear 112 is located between the ring gear 108 and the front sprocket 30 to change the rotation direction. The transmission gear 112, the ring gear 108, and the front sprocket 30 form a planetary gear mechanism. In this case, the transmission gear 112 functions as a planetary gear, the ring gear 108 functions as a sun gear, and the front sprocket 30 functions as a ring gear. A carrier that supports the transmission gear 112 is fixed to a housing to reverse the rotation direction of the sun gear 94 and the rotation direction of the front sprocket 30. The transmission gear 112 can be located between the crankshaft 42 and the sun gear 106.

As shown in FIG. 16, in the drive unit 102 shown in FIG. 15, the first motor 48 can be connected to the ring gear 108. In this case, the torque of the first motor 48 is transmitted to the ring gear 108.

The above embodiment and the modified example may he appropriately combined or substituted. Those skilled in the art should understand the advantages obtained from such combinations and substitutions. The present invention is not limited to the exemplified description. For example, the exemplified features are not to be understood as being essential to the present invention, and the subject matter of the present invention may exist in features that are less than all of the features in a certain embodiment that has been described.

1. A bicycle drive unit comprising:
a planetary gear mechanism that includes a sun gear, a ring gear arranged around the sun gear to be coaxially with the sun gear, a plurality of planetary gears located between the sun gear and the ring gear, and a carrier that rotatably holds the planetary gears and receives rotation of a crankshaft;
a first motor configured to transmit torque to the carrier; and
a second motor configured to transmit torque to the sun gear and control rotation of the sun gear.

2. The bicycle drive unit according to claim 1, further comprising
an output portion that can be coupled to a front sprocket, the ring gear being connected to the output portion.

3. The bicycle drive unit according to claim 1, further comprising
the crankshaft, the crankshaft and the carrier being connected.

1. The bicycle drive unit according to claim 1, wherein
the carrier is arranged around the crankshaft to be coaxially with the crankshaft.

5. The bicycle drive unit according to claim 4, wherein
the sun gear is arranged around the crankshaft to be coaxially with the crankshaft.

6. The bicycle drive unit according to claim 1, wherein
the second motor is arranged around the crankshaft to be coaxially with the crankshaft.

7. The bicycle drive unit according to claim 6, wherein
the second motor is arranged around the crankshaft to be coaxially with the crankshaft, and
the sun gear is formed integrally with an output shaft of the second motor.

8. The bicycle drive unit according to claim 1, wherein
a rotation shaft of the first motor is separated from the crankshaft in a radial direction of the crankshaft.

9. The bicycle drive unit according to claim 1, further comprising:
a housing that accommodates at least the planetary gear mechanism; and
a one-way clutch located between the sun gear and the housing, the one-way clutch allowing the sun gear to rotate relative to the housing in only a single direction.

10. The bicycle drive unit according to claim 1, further comprising:
a housing that accommodates at least the planetary gear mechanism; and
a one-way clutch located between an output shaft or rotor of the second motor and the housing, the one-way clutch allowing the output shaft or rotor of the second motor to rotate relative to the housing in only a single direction.

11. The bicycle drive unit according to claim 9, wherein
the sun gear is arranged around the crankshaft to be coaxially with the crankshaft, the housing includes a support located in a space extending between an inner circumference of the sun gear and the crankshaft, and
the one-way clutch is located between the sun gear and the support.

12. The bicycle drive unit according to claim 2, further comprising
a one-way clutch located between the crankshaft or the carrier and the ring gear or the output portion, the one-way clutch allowing the output portion to rotate relative to the crankshaft in only a single direction.

13. The bicycle drive unit according to claim 9, wherein
at least one of the first motor and the second motor is accommodated in the housing.

14. The bicycle drive unit according to claim 1, wherein
the second motor changes a transmission ratio of the planetary gear mechanism including at least a range from 1.2 to 1.5.

15. The bicycle drive unit according to claim 1, wherein
the second motor changes a transmission ratio of the planetary gear mechanism in a range from 0.2 to 3.0.

16. The bicycle drive unit according to claim 1, further comprising
a controller that controls the first motor and the second motor.
